(19) United States
(12) Patent Application Publication
(10) Pub. No.: US 2025/0363622 A1
(43) Pub. Date: Nov. 27, 2025

(54) INSPECTION DEVICE AND INSPECTION METHOD

(71) Applicant: KONICA MINOLTA, INC., Tokyo (JP)

(72) Inventors: Shunichi Kumakura, Tokyo (JP); Naoki Uchikawa, Tokyo (JP)

(73) Assignee: KONICA MINOLTA, INC., Tokyo (JP)

(21) Appl. No.: 19/215,946

(22) Filed: May 22, 2025

(30) Foreign Application Priority Data
May 23, 2024 (JP) 2024-083738

(51) Int. Cl. G06T 7/00; B41J 3/44; B41J 11/00; B41J 13/22; G06K 15/02; H04N 1/00

(52) U.S. Cl. CPC G06T 7/001; G06K 15/023; H04N 1/00045; H04N 1/00092; B41J 3/445; B41J 11/0095; B41J 13/226; G06T 2207/10008; G06T 2207/10024; G06T 2207/30144

(57) ABSTRACT

An inspection device includes: a holder that holds an inspection medium that is a medium on which an image is formed; an image sensor that reads the image on the inspection medium; and a controller that inspects the inspection medium by comparing, with a reference image, an inspection image obtained by performing image processing on a read image read by the image sensor. The holder has a non-plane surface as a holding surface, and the controller changes one or both of the inspection image and the reference image based on a transparency of the medium.

### CROSS-REFERENCE TO RELATED APPLICATIONS

The entire disclosure of Japanese patent Application No. JP2024-083738, filed on May 23, 2024, is incorporated herein by reference in its entirety.

### BACKGROUND OF THE INVENTION

### Technical Field

The present invention relates to an inspection device and an inspection method, and relates to, for example, an inspection device for inspecting the quality of a light-transmitting medium which is suctioned to a cylindrical drum and on which an image is formed.

### Description of Related Art

An inspection device inspects a failure of an image formed on a medium or a dust adhering to a medium on which an image is formed. JP2004-219072A discloses a technique of removing streaks other than those to be inspected by taking a difference between an image of an inspection target portion and a background image, which is an inspection method for a liquid crystal surface. The background image is obtained by imaging a plurality of samples having as few defects as possible, creating an averaged image thereof, and extracting only a screen portion of an inspected portion from the image.

When an image is formed by causing a medium to be suctioned and held on a cylindrical drum, the medium may be a light-transmitting medium such as a transparent medium or a semi-transparent medium. The drum has a plurality of holes for suction. Therefore, when the inspection device inspects the image formed on the light-transmitting medium, the plurality of holes for suction are seen through. In order to remove an image of a suction surface (holding surface) that suctions (holds) the inspection medium to the drum, it is conceivable that the inspection device could apply the technique described in JP2004-219072A. However, the background image described in JP2004-219072A is based on an averaged image of a plurality of images of a sample without defects. That is, the technique described in JP2004-219072A detects defects on the medium itself. Therefore, the technique of JP2004-219072A cannot be applied to the invention that aims at transmission of a background image through a light-transmitting medium.

### SUMMARY OF THE INVENTION

The present invention has been made in view of the above problems. An object of the present invention is to provide an inspection device and an inspection method capable of eliminating an influence of an image of a holding surface that holds an inspection medium.

The above object of the present invention is achieved by the following means.

To achieve at least one of the abovementioned objects, according to an aspect of the present invention, an inspection device reflecting one aspect of the present invention comprises: a holder (suction part) that holds (suctions) an inspection medium (image forming medium); that is a medium on which an image is formed; an image sensor that reads the image on the inspection medium; and a controller that inspects the inspection medium by comparing an inspection image obtained by performing image processing on a read image read by the image sensor with a reference image (comparison image), wherein the holder has a non-plane surface (for example, a surface having a plurality of suction holes) as a holding surface, and the controller changes one or both of the inspection image and the reference image based on a transparency of the medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram of an inspection device according to each embodiment of the present invention.

FIG. 2 is a configuration diagram around an image forming part (or image forming device) of the inspection device.

FIG. 3A is a diagram (1) showing a structure of a holding part (or holder) that holds an inspection medium.

FIG. 3B is a diagram (2) showing the structure of the holding part that holds the inspection medium.

FIG. 3C is a diagram (3) showing the structure of the holding part that holds the inspection medium.

FIG. 4 shows an inspection method of a first embodiment of the present invention, and explains the inspection method by comparing an inspection image obtained by subtracting a background image from a read image obtained by reading an inspection medium with a reference image.

FIG. 5 is a flowchart for explaining a method of generating the reference image in the inspection method of a first embodiment of the present invention.

FIG. 6 is a diagram for explaining a method of reading the background image by a reading part (or image sensor).

FIG. 7 is a diagram for explaining a method of reading a reference read image or an inspection read image.

FIG. 8 is a flowchart for explaining a method of generating the inspection image and comparing the inspection image with the reference image in the inspection method of the first embodiment of the present invention.

FIG. 9 shows an inspection method of a second embodiment of the present invention, and explains the inspection method by comparing an inspection image obtained by combining a read image obtained by reading an inspection medium and a background image with a reference image.

FIG. 10 is a flowchart for explaining a method of generating the inspection image and comparing it with the reference image in the inspection method of the second embodiment of the present invention.

FIG. 11 shows an inspection method of a third embodiment of the present invention, and explains the inspection method by comparing an inspection image obtained by subtracting a background image from a read image obtained by reading an inspection medium with a reference image.

FIG. 12 shows an inspection method of a fourth embodiment of the present invention, and explains the inspection method by comparing an inspection image, which is obtained by combining a read image obtained by reading an inspection medium and a background image, with a reference image.

FIG. 13 shows an example of an operation setting screen in a fifth embodiment of the present invention.

FIG. 14 shows an example of a medium to which a mark indicating inspection stop is added when the inspection device stops the inspection operation.

FIG. 15 is a flowchart for explaining an inspection interruption process executed by the inspection method of the fifth embodiment of the present invention.

FIG. 16 shows an example of a designation screen for designating an operation when the inspection is interrupted.

FIG. 17 is a flowchart for explaining an inspection method of a sixth embodiment of the present invention.

FIG. 18 is a flowchart for explaining a method of generating an inspection image and comparing the inspection image with a reference image in an inspection method of the sixth embodiment of the present invention.

### DETAILED DESCRIPTION

Hereinafter, one or more embodiments of the present invention will be described with reference to the drawings. However, the scope of the invention is not limited to the disclosed embodiments.

In the following embodiments, embodiments of the present invention will be described in detail with reference to the drawings. The drawings are schematically shown to the extent that the present invention can be fully understood. Thus, the present invention is not limited to the shown examples. In the drawings, common components and similar components are denoted by the same reference numerals, and redundant description thereof will be omitted.

The inspection device 100 of embodiments of the present invention includes a holding part or holder (for example, drum 6) that holds (suctions) an inspection medium (image forming medium), which is a medium P on which an image is formed; a reading part (or image sensor) 1 that reads an image on the inspection medium; and an inspection part 25 that inspects the inspection medium by comparing an inspection image obtained by an image processing of a read image read by the reading part with a reference image (comparison image), wherein a holding surface (suction surface) 6d of the holding part is a non-plane surface (for example, a surface having a plurality of suction holes), and the inspection part changes one or both of the inspection image and the reference image based on a transparency (for example, transmittance) of the medium.

### First Embodiment

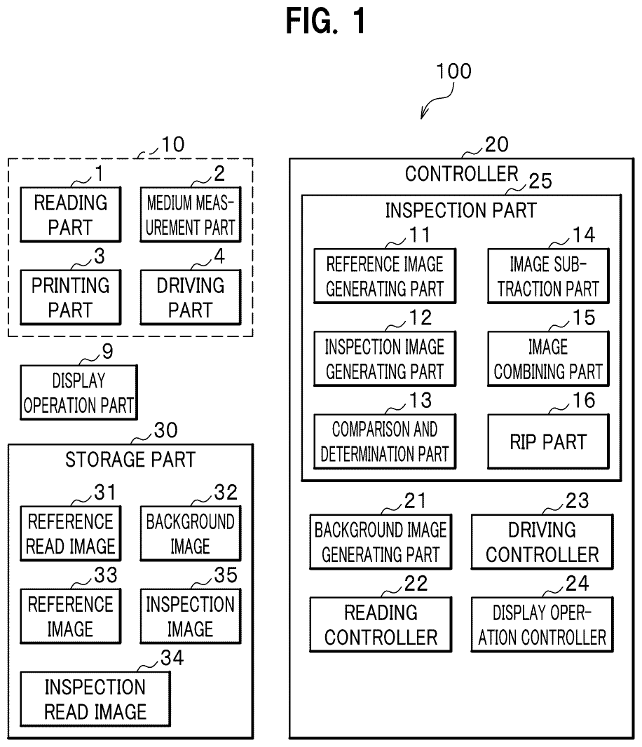

FIG. 1 is a configuration diagram of an inspection device according to a first embodiment of the present invention.

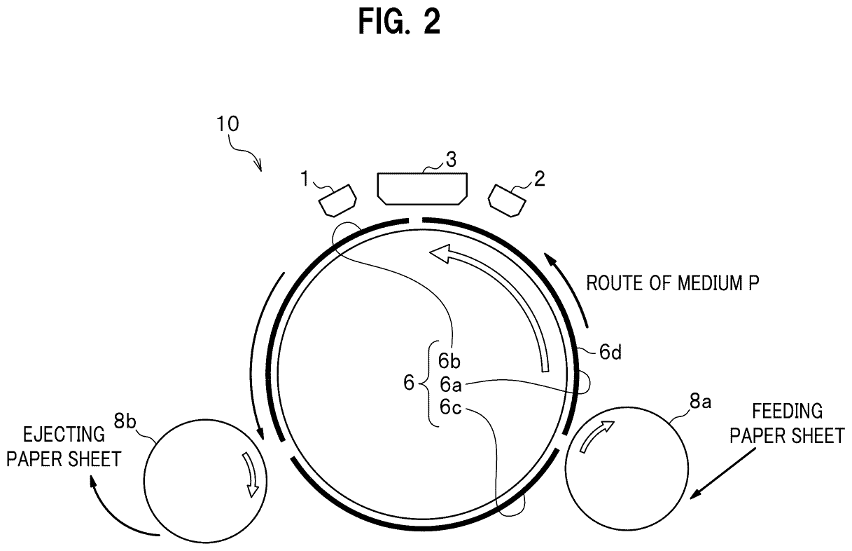

The inspection device 100 inspects an inspection medium, which is a medium on which an image is formed (particularly, a light-transmitting medium such as a transparent medium or a semi-transparent medium). The inspection device 100 includes an image forming part (or image forming device) 10, a display operation part 9, a controller 20, and a storage part (or storage) 30. The image forming part 10 forms an image on a medium P (FIG. 2) suctioned to a cylindrical drum 6 (FIG. 2). The image forming part 10 includes a reading part (or reader) 1, a medium measurement part (or medium sensor) 2, a printing part (or printer) 3, and a driving part (or driver) 4. The display operation part 9 is an I/O interface such as a touch screen and functions as an input part and a display part.

FIG. 2 is a configuration diagram around an image forming part of the inspection device. The image forming part 10 includes the drum 6, the reading part 1, the medium measurement part 2, the printing part 3, and rollers 8a and 8b. The drum 6 is a cylindrical rotating member (or cylindrical rotator), on which three sheet suction parts 6a, 6b, and 6c are arranged in the rotational direction (see white arrows). That is, the drum 6 is a rotating member (or rotator) having a cylindrical surface divided into a plurality of parts (divided surfaces) in the rotational direction.

The reading part 1 is a line sensor, and reads an image formed on the medium P being transported. The medium measurement part 2 is a medium sensor that detects light transmittance and color (hue, saturation, brightness, etc.) of a medium (paper sheet). The printing part 3 prints the medium P, which is suctioned on the surface of the drum 6 and transported, with ink or toner. The roller 8a feeds the medium P to the drum 6. The roller 8b ejects the medium P from the drum 6.

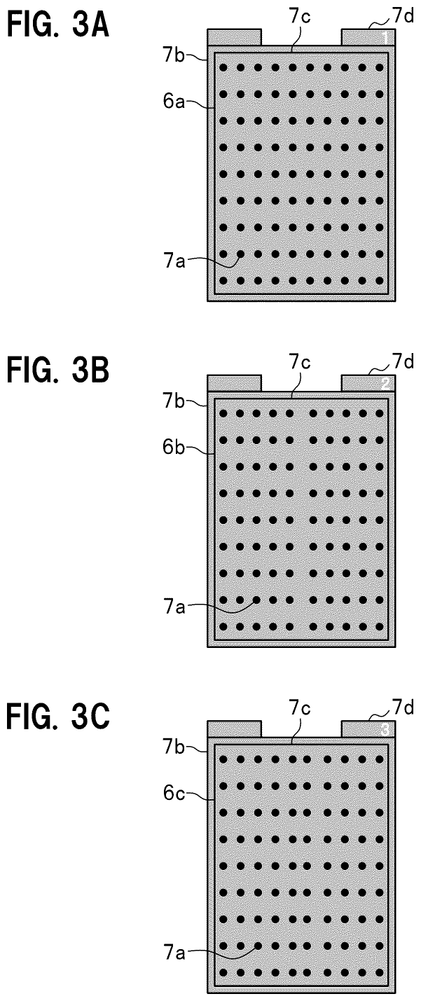

FIG. 3A, FIG. 3B, and FIG. 3C show structures of sheet suction parts as holding parts that hold medium.

The sheet suction parts 6a, 6b, and 6c are provided on the surfaces of the drum 6, and a Per fluoroalkoxy alkane (PFA) sheet 7b is attached to an upper surface of a rectangular steel special use stainless (SUS) sheet 7c. In addition, a plurality of suction holes 7b is opened in the SUS sheet 7c and the PFA sheet 7a. That is, the surfaces of the sheet suction parts 6a, 6b, and 6c are non-plane surfaces and function as suction surfaces 6d (FIG. 2) that suck (hold) medium.

A claw 7d is provided on one side of the sheet suction parts 6a, 6b, and 6c, and prevents mechanical misregistration in a transport direction of the medium P. A code (for example, a numeral “1”) is printed on the claw 7d of the sheet suction part 6a to distinguish the claw 7d from the sheet suction parts 6b and 6c. Note that the number “2” is printed on the claw 7d of the sheet suction part 6b, and the number “3” is printed on the claw 7d of the sheet suction part 6c.

Returning to the description of FIG. 1, the driving part 4 rotates a transport mechanism such as the rollers 8a and 8b (FIG. 2) for transporting medium, and the drum 6 (FIG. 2). The driving part 4 has a sensor (for example, a rotary encoder) that detects rotation angle information of the drum 6. The storage part 30 is a volatile storage part such as a random-access memory (RAM) or a non-volatile storage part such as a hard disk drive (HDD) or a solid-state drive (SSD). The storage part 30 includes areas for storing a reference read image 31, a background image 32, a reference image 33, an inspection read image 34, and an inspection image 35.

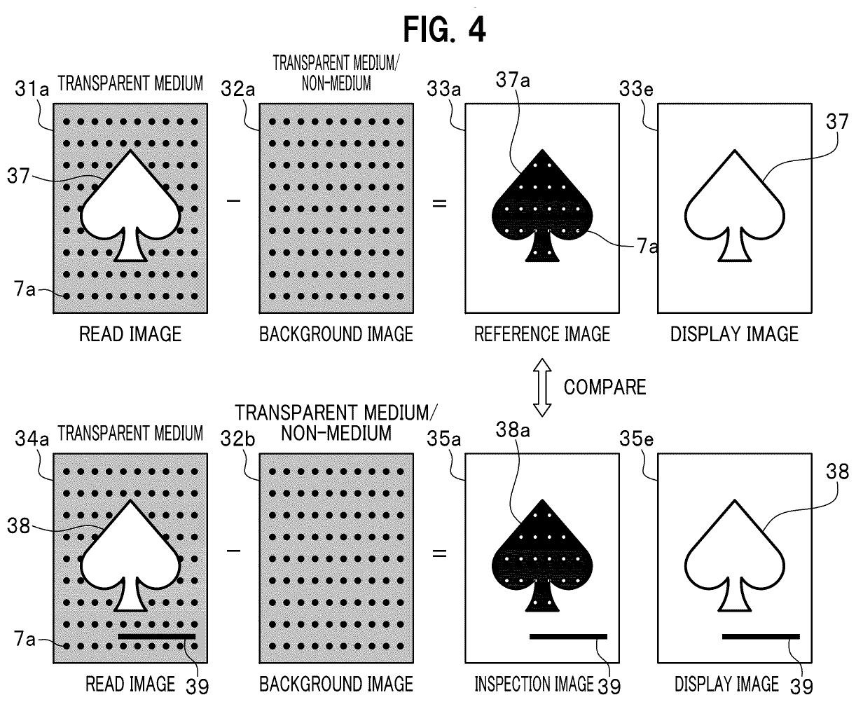

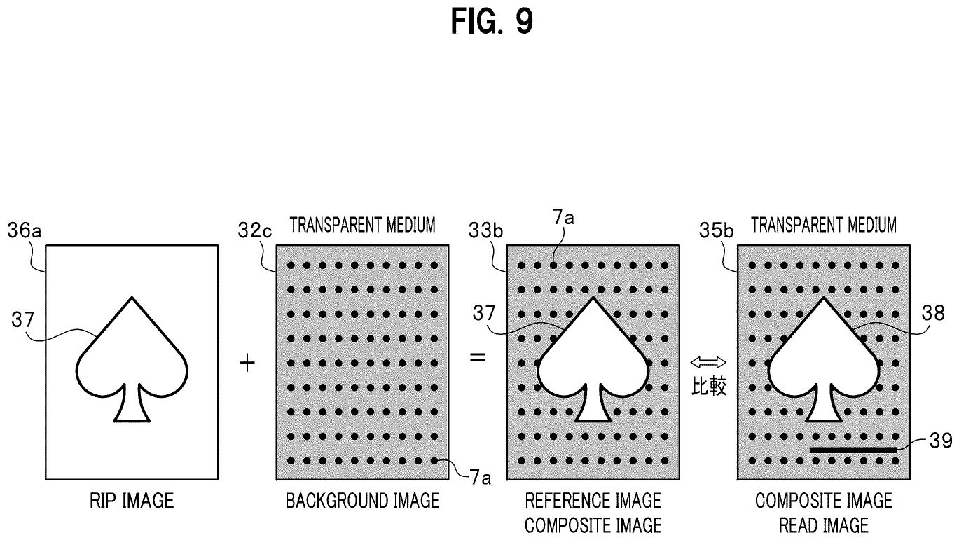

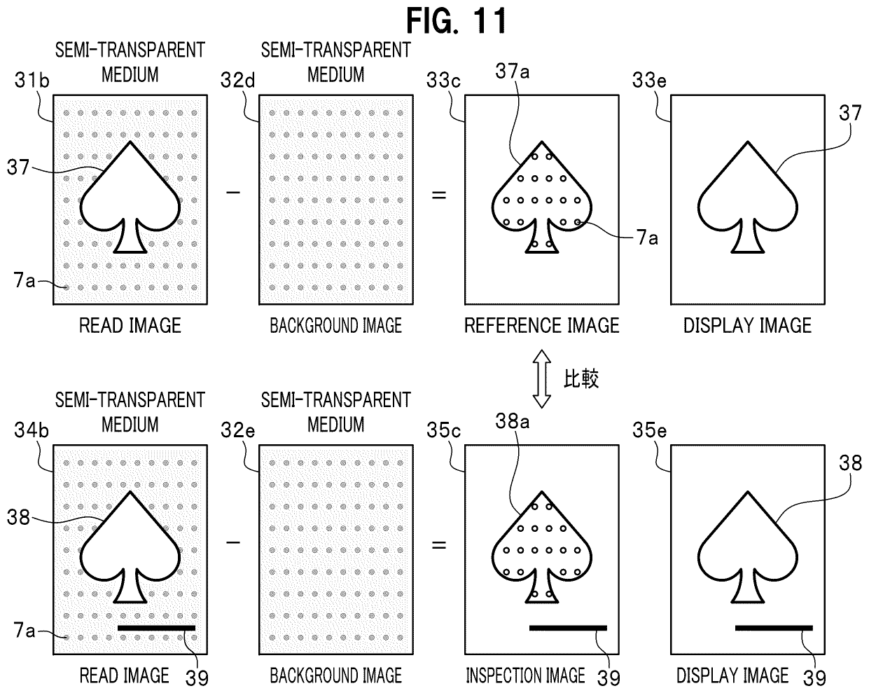

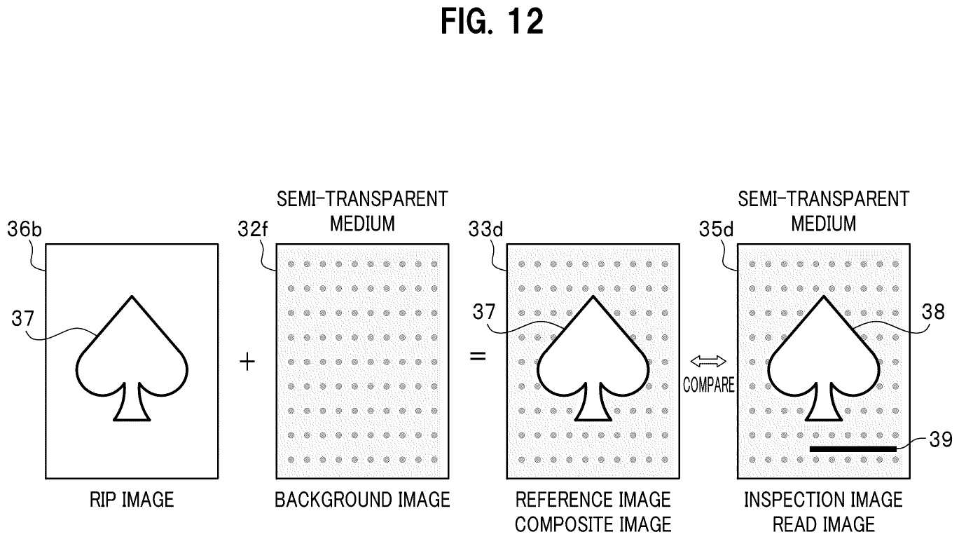

The controller 20 is a central processing unit (CPU), and realizes functions of image formation and inspection by executing a program. The controller 20 realizes functional units of the inspection part 25, a background image generating part 21, a reading controller 22, a driving controller 23, and a display operation controller 24. The inspection part 25 generates an inspection image 35 (35a (FIG. 4), 35b (FIG. 9), 35c (FIG. 11), 35d (FIG. 12)). The inspection image 35 is based on the inspection read image 34 (34a (FIG. 4), 34b (FIG. 11)) obtained by reading, in the reading part 1, the front side of the inspection medium, which is a light-transmitting medium such as a transparent medium or a semi-transparent medium on which an image is formed. Further, the inspection part 25 performs inspection by comparing the generated inspection image 35 (35a, 35b, 35c, 35d) with the reference image 33 (33a (FIG. 4), 33b (FIG. 9), 33c (FIG. 11), and 33d (FIG. 12)). That is, the reference image 33 is a comparison image to be compared with the inspection image 35.

The background image generating part 21 generates the background image 32 (32a (FIG. 4), 32b (FIG. 4), 32c (FIG. 9), 32d (FIG. 11), 32e (FIG. 11), 32f (FIG. 12)). The background image 32 is an image obtained by the reading part 1 viewing the surfaces of the sheet suction parts 6a, 6b, and 6c through a light-transmitting medium such as a transparent medium or a semi-transparent medium. The reading controller 22 controls the reading part 1. The driving controller 23 controls the driving part 4. The display operation controller 24 controls the display operation part 9.

The inspection part 25 changes one or both of the inspection image 35 and the reference image 33 based on the transparency (transmittance) of the medium. That is, the inspection image 35 and the reference image 33 are changed not only in this embodiment but also in second, third, and fourth embodiments to be described later. In this embodiment, the inspection image 35 and the reference image 33 are images obtained by subtracting the background image 32 from the read image (the reference read image 31 or the inspection read image 34) (see FIG. 4).

The inspection image 35, the reference image 33, and the background image 32 are generated for respective divided surfaces of the cylindrical surface of the drum 6, and each image is stored in the storage part 30. The inspection part 25 compares the inspection image 35 with the reference image 33 while recognizing images of the divided surfaces, thereby performing inspection.

The inspection part 25 includes a reference image generating part 11, an inspection image generating part 12, a comparison and determination part 13, an image subtraction part 14, an image combining part 15, and a raster image processor (RIP) part 16. The reference image generating part 11 generates reference images 33 (33a (FIG. 4), 33b (FIG. 9), 33c (FIG. 11), 33d (FIG. 12)). The reference image 33 is based on an image of a reference medium (reference read image 31 (31a (FIG. 4), 31b (FIG. 11))) ideally formed on a light-transmitting medium without a scratch or failure. The inspection image generating part 12 generates inspection images 35 (35a (FIG. 4), 35b (FIG. 9), 35c (FIG. 11), 35d (FIG. 12)) based on the images of the inspection mediums, that is, the images formed on the plurality of light-transmitting mediums.

The comparison and determination part 13 compares the inspection image 35 with the reference image 33 to inspect the inspection medium. The image subtraction part 14 subtracts the background image 32 from the read image (reference read image 31 or inspection read image 34) when obtaining the inspection image 35 or reference image 33 (see FIG. 4 and FIG. 11). The image combining part 15 combines the read image and the background image 32 (see FIG. 9 and FIG. 12). The RIP part 16 converts the input data such as an image and a font into halftone dot data, and converts the color into halftone dot data of four colors of YMCK. The RIP part 16 generates the RIP image 36a (FIG. 9) including the material image 37 (FIG. 4).

FIG. 4 shows an inspection method of a first embodiment of the present invention. In this embodiment, the inspection image obtained by subtracting the background image from the e-read image obtained by reading the surface of the inspection medium, which is the transparent medium on which the image is formed, is compared with the reference image.

The reference read image 31a is an image obtained by reading the suction surface 6d (FIG. 2) of the drum 6 by the reading part 1 in a state where the reference medium (image formation transparent medium) obtained by forming the material image 37 on the transparent medium (transparent plane medium) is suctioned to the suction surface 6d. Here, the material image 37 is, for example, an image of a spade mark. In the reference read image 31a, images of sheet suction parts 6a, 6b, and 6c (FIG. 3A, FIG. 3B, and FIG. 3C) (particularly, images of a plurality of suction holes 7a) are reflected outside the material image 37. The background image 32a is a suction surface image read by the reading part 1 in a state where the transparent medium is suctioned to the suction surface 6d (FIG. 2). The background image 32a may be an image obtained by reading the image of the suction surface 6d by the reading part 1 in a non-medium state. The background image 32a is an image of the suction surface 6d as a holding surface, and thus is a holding surface image.

The reference image 33a is an image obtained by subtracting the background image 32a from the reference read image 31a. In the reference image 33a, the images of the plurality of suction holes 7a (FIG. 3A, FIG. 3B, FIG. 3C) reflected outside the material image 37 are deleted. However, the shape of the plurality of suction holes 7a is reflected inside the material image 37. That is, inside the material image 37, the color of the suction hole 7a or the color around the suction hole 7a changes due to the subtraction.

The inspection read image 34a is an image obtained by reading the front side of the inspection medium, which is a transparent medium on which the inspected image 38 is formed, by the reading part 1. The inspected image 38 is the same image as the material image 37. At this time, the inspection read image 34a is added with not only the inspected image 38 and the images of the suction surfaces 6d (FIG. 2) of the sheet suction parts 6a, 6b, and 6c (FIG. 3A, FIG. 3B, and FIG. 3C) (particularly, the images of the plurality of suction holes 7a) but also a faulty printed image 39. The background image 32b is the same image as the background image 32a described above. The inspection image 35a is an image obtained by subtracting the background image 32b from the inspection read image 34a. The inspection image 35a includes the faulty printed image 39. In addition, in the inspection image 35a, like the reference image 33a, the image of the plurality of suction holes 7a reflected outside the inspected image 38 is deleted. Further, the shape of the plurality of suction holes 7a is reflected inside the inspected image.

The comparison and determination part 13 (FIG. 1) compares the inspection image 35a with the reference image 33a. In both of the inspection image 35a and the reference image 33a, there is an image of the plurality of suction holes 7a reflected inside the material image 37 and the inspected image 38. Therefore, the inspection image 35a and the reference image 33a are different only in the faulty printed image 39. Note that a reading display image 33e and an inspection display image 35e are shown at the right end of FIG. 4. The reading display image 33e and the inspection display image 35e are displayed by the display operation part 9 instead of the reference image 33a and the inspection image 35a as necessary. Only the material image 37 exists in the reading display image 33e, and the inspected image 38 and the faulty printed image 39 exist in the inspection display image 35e.

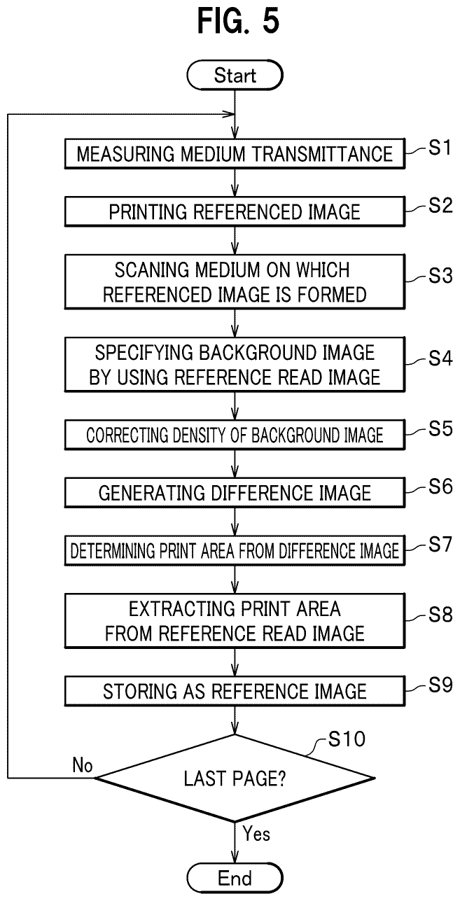

FIG. 5 is a flowchart for explaining a method of generating the reference image in the inspection method of the first embodiment of the present invention.

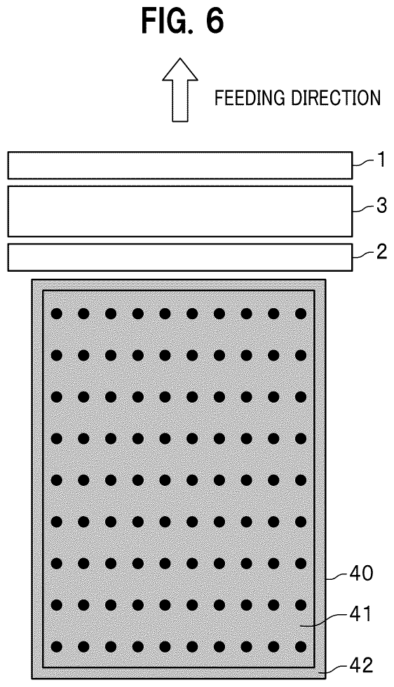

In this embodiment, a plurality of (three) background images (images of sheet suction parts 6a, 6b, 6c of the suction surface 6d (FIG. 2)) 32 are stored in the storage part 30 in advance. That is, as shown in FIG. 6, the reading part 1 captures images of the surfaces of the sheet suction parts 6a, 6b, and 6c in a state where the drum 6 (FIG. 2) suctions the transparent medium. Here, the medium transport (empty feed) is performed while stopping the rotation of the drum 6 so that alignment of the medium (paper sheet) and the sheet suction parts 6a, 6b, and 6c is completed. In FIG. 6, an area of a transparent medium 40, a print area 41, and a non-print area 42 are shown.

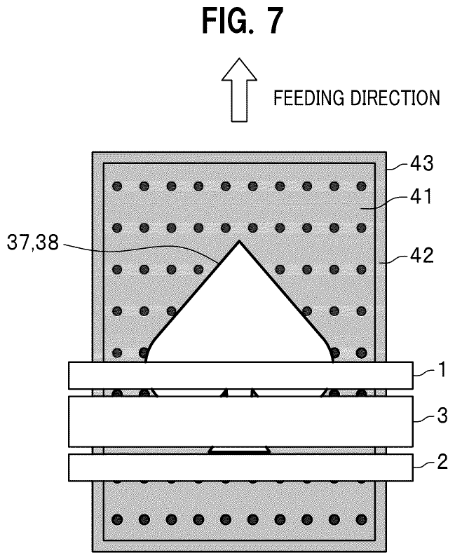

When the flow is started, the inspection part 25 measures the medium transmittance (in this embodiment, since the medium is a transparent medium, transmittance 32 100%) using the medium measurement part 2 (step S1). After the step S1 is executed, the reference image generating part 11 prints the material image 37 (FIG. 4) on the medium as shown in FIG. 7 (step S2). Reference numeral 43 in FIG. 7 denotes an image forming medium, which is a medium on which an image is formed. After step S2 is executed, the reading controller 22 causes the reading part 1 to scan the medium (transparent medium in this embodiment) on which the material image 37 is formed (step S3).

After the execution of the step S3, the reference image generating part 11 specifies (identifies) the background image 32a by using the reference read image 31a scanned in the step S3 (step S4). To be more specific, the reference image generating part 11 uses the reference read image 31a to identify the reference read image from among a plurality of (three) background images (images of the suction surfaces 6d of the sheet suction parts 6a, 6b, and 6c (holding surface images)) stored in the storage part 30. After the execution of step S4, the reference image generating part 11 corrects the density of the background image 32a (FIG. 4) specified in step S3 using the transmittance of the medium measured in step S1 (step S5). In this embodiment, since transmittance=100%, density correction of the background image 32a is not substantially performed. After the execution of the step S5, the image subtraction part 14 subtracts the background image 32a from the reference read image 31a to generate a difference image (reference image 33a) (step S6). After the execution of step S6, the reference image generating part 11 determines the print area 41 (FIG. 6) from the difference image (reference image 33a) (step S7). The print area 41 is an area where there is no change in comparison between the outer edges of the reference image 33a and the reference read image 31a, for example. After the execution of the step S7, the reference image generating part 11 extracts the print area 41 determined in the step S7 from the reference read image 31a (FIG. 4) scanned in the step S3 (step S8). After the step S8 is executed, the reference image generating part 11 stores the image extracted in the step S8 as a reference image in the storage part 30 (step S9). After the execution of the step S9, the reference image generating part 11 determines whether or not the last page of the material image 37 is subjected to the printing, scanning, or the like (step S10).

If the subject is not the last page (No in step S10), the process returns to step S1, and the reference image generating part 11 prints the material image of the next page on the medium. On the other hand, if the subject is the last page (Yes in step S10), the process of FIG. 5 is terminated.

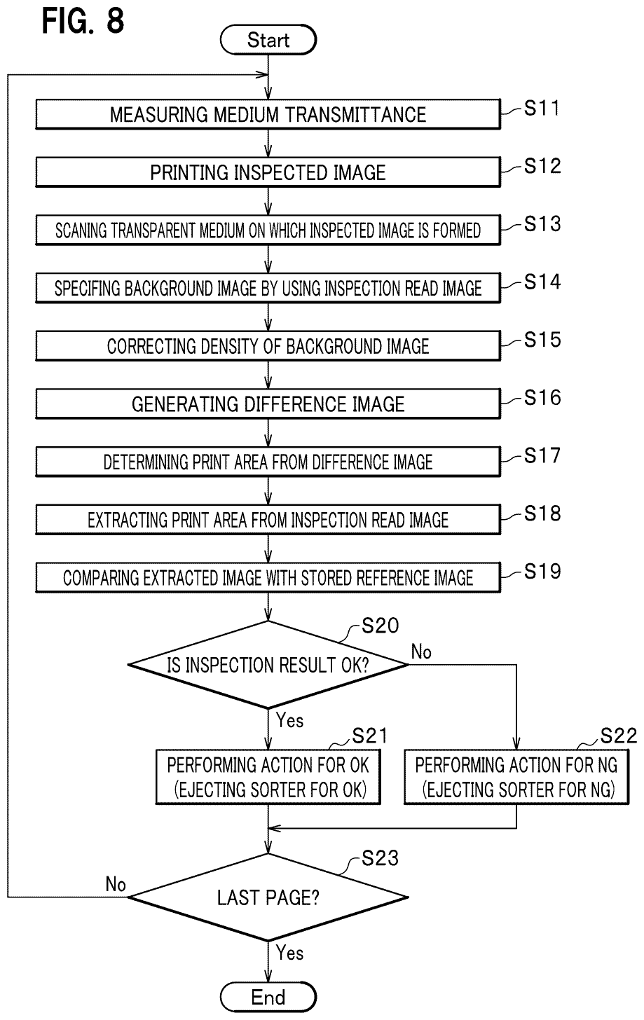

FIG. 8 is a flowchart for explaining a method of generating an inspection image and comparing the inspection image with the reference image in the inspection method of the first embodiment of the present invention.

The inspection image generating part 12 measures the medium transmittance using the medium measurement part 2 (step S11). After the execution of step S11, the inspection image generating part 12 prints the inspected image 38 (FIG. 4) on the medium (transparent medium in this embodiment) as shown in FIG. 7 (step S12). After step S12, the reading controller 22 scans the transparent medium on which the inspected image 38 is formed by the reading part 1 (step S13).

After the execution of the step S13, the inspection image generating part 12 specifies (identifies) a background image 32b by using the inspection read image 34a (FIG. 4) scanned in the step S13 (step S14). After step S14 is executed, the inspection image generating part 12 corrects the density of the background image 32b (FIG. 4) specified in step S14 using the transmittance of the medium measured in step S11 (100% in this embodiment) (step S15). In this embodiment, since transmittance=100%, density correction of the background image 32b is not substantially performed. After the execution of the step S15, the image subtraction part 14 subtracts the background image 32b from the inspection read image 34a to generate a difference image (inspection image 35a) (step S16). After the execution of step S16, the inspection image generating part 12 determines the print area 41 (FIG. 6) from the difference image (inspection image 35a) (step S17). The print area 41 is an area where there is no change in comparison between that does the outer edges of the inspection image 35a and the inspection read image 34a, for example. When the area determined in step S7 (FIG. 5) is larger, the larger area is used as the print area 41. After the execution of the step S17, the inspection image generating part 12 extracts the print area 41 determined in the step S17 from the inspection read image 34a (FIG. 4) scanned in the step S13 (step S18).

After the execution of step S18, the comparison and determination part 13 (FIG. 1) compares the image extracted in step S18 with the reference image stored in the storage part 30 in step S9 (FIG. 5) (step S19), and performs inspection. After the execution of step S19, the comparison and determination part 13 determines whether or not the inspection result is OK (good) (step S20). If the inspection result is OK (Yes in step S20), the driving controller 23 (FIG. 1) performs control so as to eject the inspection medium to a sorter for OK (step S21). On the other hand, if the inspection result is NG (not good) (No in step S20), the driving controller 23 performs control so as to eject the inspection medium to a sorter for NG (step S22). After the step S21 or the step S22 is executed, the controller 20 determines whether or not the last page of the inspected image 38 is subjected to the printing, the scanning, or the like (step S23). If the subject is not the last page (No in step S23), the process returns to step S11, and the inspection image generating part 12 performs control so as to print the inspected image of the next page on the medium. On the other hand, if the subject is the last page (Yes in step S23), the process of FIG. 8 is terminated. That is, the reference image is stored in the storage part 30 over a plurality of pages from the first page to so as to correspond to each page of the inspection medium.

As described above, according to the inspection device 100 of this embodiment, the reference image 33a is obtained by subtracting the background image 32a from the reference read image 31a (FIG. 4) printed on the transparent medium. Further, by subtracting the background image 32b from the inspection read image 34a printed on the transparent medium, the inspection image 35a is obtained. Then, the inspection device 100 inspects the inspection medium by comparing the reference image 33a with the inspection image 35a.

The inspection device 100 carries out the inspection medium to a sorter for OK when the inspection result is OK, and carries out the inspection medium to a sorter for NG when the inspection result is NG.

### Second Embodiment

In the first embodiment, the inspection part 25 sets the reference image 33a obtained by subtracting the background image 32a from the reference read image 31a (FIG. 4) printed on the transparent medium, and sets the inspection image 35a obtained by subtracting the background image 32b from the inspection read image 34a printed on the transparent medium. Then, the inspection part 25 compares the reference image 33a with the inspection image 35a. In this embodiment, the inspection part 25 sets a composite image obtained by combining the RIP image 36a (FIG. 9) when the material image is printed and the background image 32c as a reference image 33b, and compares the reference image 33b with the inspection image 35b printed on the transparent medium.

FIG. 9 shows an inspection method of a second embodiment of the present invention, and explains the inspection method by comparing the inspection image obtained by combining the read image obtained by reading the inspection medium and the background image with the reference image. The inspection medium was configured by forming an image of the inspected image 38 on a transparent medium.

The RIP image 36a is an image of the material image 37 when the material image 37 is formed on the transparent medium. In the RIP image 36a, the outside (background) of the material image 37 is transparent or transmissive. The background image 32c is the same as the background image 32a (FIG. 4) of the embodiment. That is, the background image 32c is a suction surface image read by the reading part 1 in a state where the transparent medium is suctioned to the suction surface 6d (FIG. 2) of the drum 6.

The reference image 33b is a composite image obtained by combining the RIP image 36a and the background image 32c. In the reference image 33b, the outside of the material image 37 is replaced with the background image 32c, and the inside of the material image 37 is the material image 37 itself. That is, unlike the reference image 33a (FIG. 4), the shape of the plurality of suction holes 7a (FIG. 3A, FIG. 3B, FIG. 3C) is not reflected in the material image 37. In other words, the inside of the material image 37 is not affected by the background image 32c. Note that an image (not shown), in which the shape of the plurality of suction holes 7a is reflected, is an added image and is distinguished from a composite image.

The inspection image 35b is a read image obtained by reading an image forming medium, which is a transparent medium on which the inspected image 38 is formed, by the reading part 1. The faulty printed image 39 is added to the inspection image 35b. The comparison and determination part 13 (FIG. 1) compares the reference image 33b with the inspection image 35b to inspect the image.

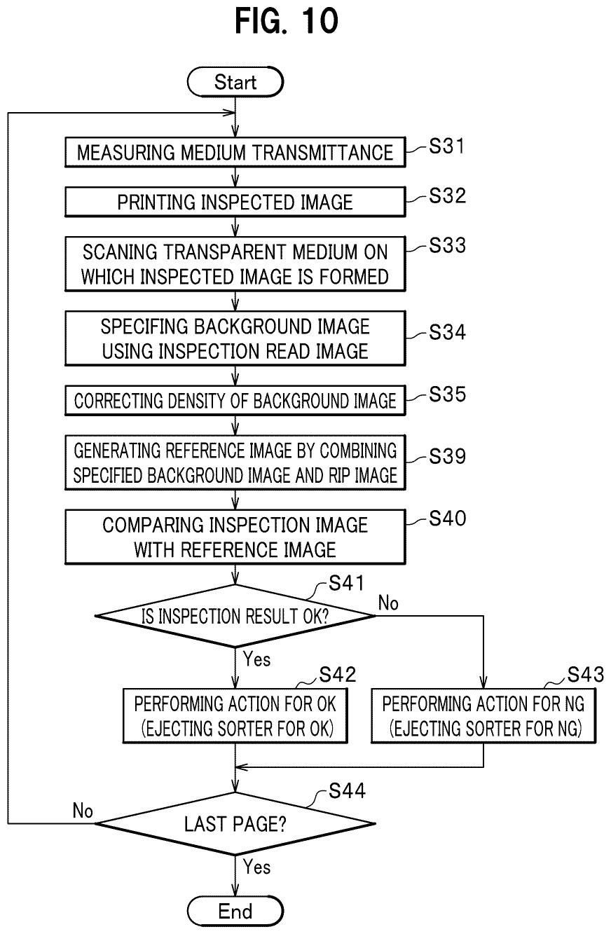

FIG. 10 is a flowchart for explaining a method of generating the inspection image and comparing it with the reference image in the inspection method of the second embodiment of the present invention.

When the flow is started, the inspection image generating part 12 measures the medium transmittance by using the medium measurement part 2 (step S31). After the step S31 is performed, the inspection image generating part 12 prints the inspected image 38 (FIG. 9) on a transparent medium as shown in FIG. 7 (step S32). After step S32, the reading controller 22 scans the transparent medium on which the inspected image 38 is formed by the reading part 1 (step S33).

After the execution of step S33, the inspection image generating part 12 specifies the background image 32c (FIG. 9) using the inspection read image (not shown) scanned in step S33 (step S34). After step S34 is executed, the inspection image generating part 12 corrects the densities of the background image 32c specified in step S33 and the background portion of the inspection image 35b using the transmittance (100% in this embodiment) of the medium measured in step S31 (step S35). In this embodiment, since transmittance=100%, density correction of the background image 32a is not substantially performed. The inspection image is generated after the execution of the step S35.

After the execution of step S35, the comparison and determination part 13 (FIG. 1) generates the reference image 33b (FIG. 9) by combining the background image 32c specified in step S34 and the RIP image 36a (FIG. 9) of the page to be inspected (step S39). The comparison and determination part 13 compares the inspection image 35b generated in the step S39 with the reference image 33b (step S40), and performs inspection. After the execution of step S40, the comparison and determination part 13 determines whether or not the inspection result is OK (step S41). If the inspection result is OK (Yes in step S41), the driving controller 23 (FIG. 1) performs control so as to eject the inspection medium to a sorter for OK (step S42). On the other hand, if the inspection result is NG (No in step S41), the driving controller 23 performs control so as to eject the inspection medium to a sorter for NG (step S43). After the step S42 or the step S43 is executed, the controller 20 determines whether or not the last of the inspection image (not shown) is subjected to the printing, the scanning, or the like (step S44). If the subject is not the last page (No in step S44), the process returns to step S31, and the inspection image generating part 12 controls to print the inspected image 38 (FIG. 9) of the next page on the medium. On the other hand, if the subject is the last page (Yes in step S44), the process of FIG. 10 is terminated.

As described above, according to the inspection device 100 of this embodiment, the reference image 33b is obtained by the composite image obtained by combining the RIP image 36a (FIG. 9) when the material image is printed and the background image 32c. The inspection device 100 inspects the inspection medium by comparing the reference image 33b with the inspection image 35b printed on the transparent medium.

### Third Embodiment

In the first embodiment, the image is formed on the transparent medium, but the image may be formed on a semi-transparent medium.

FIG. 11 shows an inspection method of a third embodiment of the present invention. In this embodiment, an inspection image obtained by subtracting a background image from a read image obtained by reading the surface of an inspection medium, which is a semi-transparent medium on which an image is formed, is compared with a reference image.

The reference read image 31b is a read image obtained by reading the suction surface 6d (FIG. 2) by the reading part 1 in a state where the reference medium (image forming medium), which is a semi-transparent medium on which the material image 37 is formed, is suctioned to the drum 6. The background image 32d is a suction surface image read by the reading part 1 in a state where the semi-transparent medium is suctioned to the suction surface 6d (FIG. 2). The background image 32d has a density different from that of the background image 32a (FIG. 4). If the semi-transparent medium is colored transparent, the background image 32d is different in color from the background image 32a (FIG. 4).

The reference image 33c is an image obtained by subtracting the background image 32d from the reference read image 31b. In the reference image 33c, as shown in FIG. 4, the image of the plurality of suction holes 7a reflected outside the material image 37 is deleted. However, the shape of the plurality of suction holes 7a (FIG. 3A, FIG. 3B, FIG. 3C) is reflected inside the material image 37.

The inspection read image 34b is a read image obtained by reading the front face of the inspection medium, which is the semi-transparent medium on which the inspected image 38 is formed, by the reading part 1. The faulty printed image 39 is added to the inspection read image 34b. The background image 32e is the same image as the background image 32d described above. The inspection image 35c is an image obtained by subtracting the background image 32e from the inspection read image 34b. The inspection image 35c includes the faulty printed image 39. In addition, the shape of the plurality of suction holes 7a is reflected in the inside of the graphic of the spade mark corresponding to the inspected image 38.

The comparison and determination part 13 (FIG. 1) compares the inspection image 35c with the reference image 33c. In both of the inspection image 35c and the reference image 33c, there is an image of the plurality of suction holes 7a reflected inside the material image 37 and the inspected image 38. Therefore, the inspection image 35a and the reference image 33a are different only in the faulty printed image 39. Note that the reading display image 33e and the inspection display image 35e are shown at the right end of FIG. 11. As shown in FIG. 4, the reading display image 33e and the inspection display image 35e are displayed by the display operation part 9 as necessary.

The flowchart is the same as the flowchart of the first embodiment (FIG. 5 and FIG. 8), and thus the description thereof will be omitted. However, since the medium is a semi-transparent medium, the transmittance measured at the step S1 and the step S11 is less than 100%. In addition, density correction of the step S5 and the step S15 is substantially performed.

As described above, according to the inspection device 100 of this embodiment, the reference image 33c is obtained by subtracting the background image 32d from the reference read image 31b (FIG. 11) printed on the semi-transparent medium. In addition, the inspection image 35c is obtained by subtracting the background image 32e from the inspection read image 34b printed on the semi-transparent medium. Then, the inspection device 100 inspects the inspection medium by comparing the reference image 33c with the inspection image 35c.

### Fourth Embodiment

In the second embodiment, the image is formed on the transparent medium, but the an image may be formed on a semi-transparent medium.

FIG. 12 shows an inspection method of a fourth embodiment of the present invention, and explains the inspection method by comparing an inspection image, which is obtained by combining a read image obtained by reading an inspection medium and a background image, with a reference image. The inspection medium was configured by forming an image of the inspected image 38 on a semi-transparent medium.

The RIP image 36b is electrical data of the material image 37 formed on a semi-transparent medium. The background image 32f is identical to the background image 32e of the third embodiment (FIG. 11). That is, the background image 32f is a suction surface image read by the reading part 1 in a state where the semi-transparent medium is suctioned to the suction surface 6d (FIG. 2) of the drum 6.

The reference image 33d is a composite image obtained by combining the RIP image 36b and the background image 32f. In the reference image 33d, the outside of the material image 37 is replaced with the background image 32f, and the inside of the material image 37 is the material image 37 itself. That is, the shape of the plurality of suction holes 7a (FIG. 3A, FIG. 3B, FIG. 3C) is not reflected in the material image 37.

The inspection image 35d is an image obtained by forming the inspected image 38 on a semi-transparent medium, and the faulty printed image 39 is added thereto. The comparison and determination part 13 (FIG. 1) compares the reference image 33d with the inspection image 35d to inspect the image. Since the flowchart is the same as that in FIG. 10, the description of the inspection method will be omitted. However, since the medium is a semi-transparent medium, the transmittance measured at the step S31 is less than 100%. In addition, density correction of the step S35 is substantially performed.

As described above, according to the inspection device 100 of this embodiment, the reference image 36b is obtained by generating the composite image in which the RIP image 32f (FIG. 12) when the material image is printed and the background image 33d are combined. The inspection device 100 inspects the inspection medium by comparing the reference image 33d with the inspection image 35d printed on the semi-transparent medium.

### Fifth Embodiment

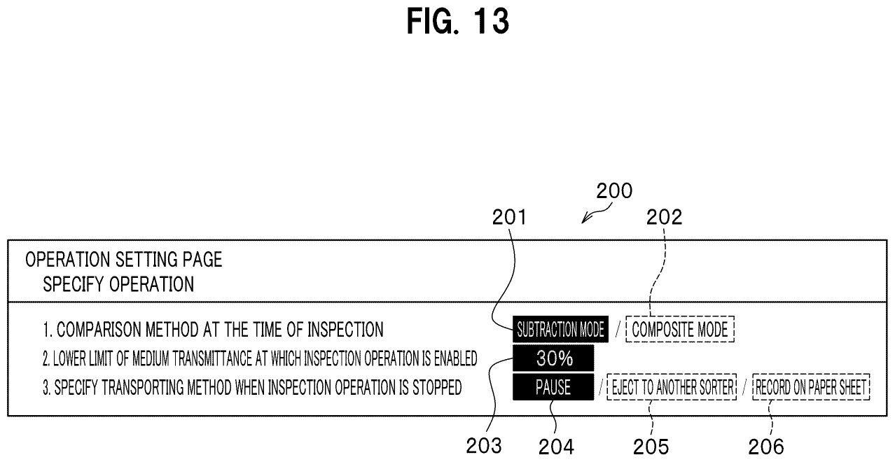

In each of the above embodiments, the inspection device 100 performs the inspection operation regardless of the transmittance of the medium, but when the transmittance of the medium is lower than a predetermined reference value, it may be better to stop the inspection. In this embodiment, the operator designates the interruption criterion of inspection and the medium transporting method at the time of stopping the inspection operation by using the operation setting screen 200 (FIG. 13).

FIG. 13 shows an example of an operation setting screen in the fifth embodiment of the present invention.

On the operation setting screen 200, a “subtraction mode” button 201 and a “composite mode” button 202 are arranged for a character string “1. Comparison method at the time of inspection”.

When the “subtraction mode” button 201 is pressed, the inspection device 100 executes the inspection method of the first embodiment or the third embodiment according to the medium type of the transparent medium or the semi-transparent medium. On the other hand, when the “composite mode” button 202 is pressed, the inspection device 100 executes the inspection method of the second embodiment or the fourth embodiment according to the medium type.

On the operation setting screen 200, a medium transmittance input box 203 is arranged for a character string “2. Lower limit of medium transmittance at which inspection operation is enabled”. The medium transmittance input box 203 functions as an input part that enables the transmittance of the medium to be specified. In the case of the inspection method of the third and fourth embodiments, it may not be preferable that the transmittance of the semi-transparent medium is too lower than the reference value. Therefore, the inspection device 100 is configured such that an operator sets the lower limit of the medium transmittance. In other words, the inspection device 100 performs the inspection operation of each embodiment when the measured value of the transmittance measured by the medium measurement part 2 is higher than the reference value.

On the operation setting screen 200, a “pause” button 204, an “eject to another sorter” button 205, and a “record on paper sheet” button 206 are arranged for a character string “3. Specify transporting method when inspection operation is stopped”.

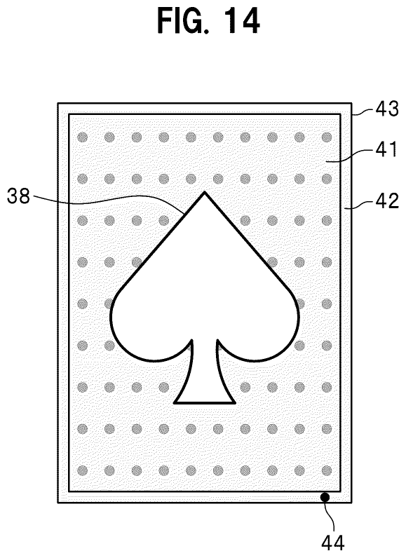

These buttons are used to select whether to temporarily stop ejecting the medium, to eject the medium to a sorter different from a sorter to which the medium is ejected when the medium is normally inspected, or to record a mark on a paper sheet (inspection medium), when the inspection device 100 stops the inspection operation. Here, a mark 44 (FIG. 14) recorded when the “record on paper sheet” button 206 is pressed indicates that the inspection medium is uninspected (uninspected due to inspection stop), and is added to the non-print area 42 (for example, the end of paper sheet on which a print result is output) of the inspection medium. The inspection medium to which the mark 44 (FIG. 14) is added is carried out to the same sorter as the sorter to which the inspection medium is carried out when the inspection medium is normally inspected.

FIG. 14 shows an example of a medium to which a mark indicating inspection stop is added when the inspection device 100 stops the inspection operation. The inspection medium is configured by forming an inspected image 38 in the print area 41, and further forming the mark 44 in the non-print area 42.

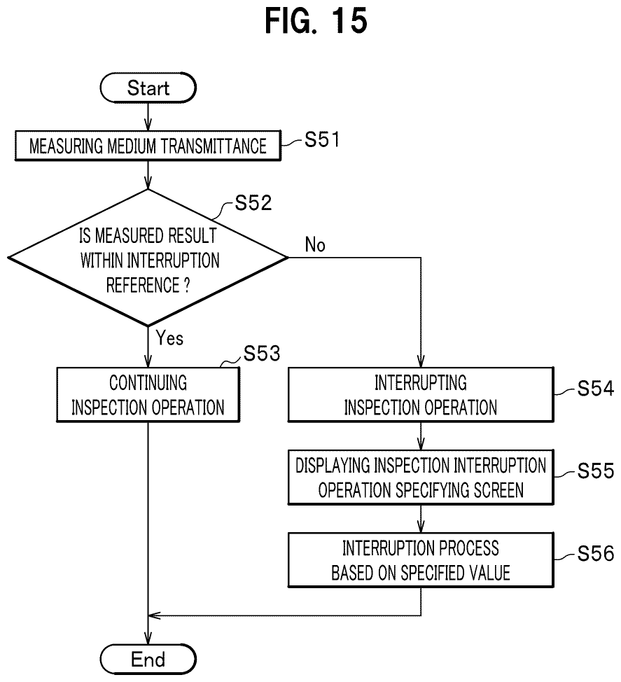

FIG. 15 is a flowchart for explaining an inspection interruption process executed by the inspection method of the fifth embodiment of the present invention. This flow is started by interruption for each processing of one page during execution of any one of the inspection methods of the respective embodiments.

The inspection part 25 measures the transmittance of the medium (step S51). After the execution of the step S51, the inspection part 25 determines whether or not the measured result of the step S51 is within the interruption reference (step S52). That is, it is determined whether or not the measured result is within the values (interruption criteria of the inspection) input to the medium transmittance input box 203 (FIG. 13) (step S52). If the difference is within the reference (Yes in step S52), the inspection part 25 continues the inspection operation (step S53). On the other hand, if the inspection operation is out of the standard (No in step S52), the inspection part 25 interrupts the inspection operation (step S54), and displays an inspection interruption operation specifying screen 210 on the display operation part 5 (step S55). At this time, the operator designates an inspection interruption operation during inspection using the inspection interruption operation specifying screen 210. After the execution of the step S55, the inspection part 25 executes the interruption process based on a specified value (step S56). After the step S53 or the step S56 is executed, the process ends.

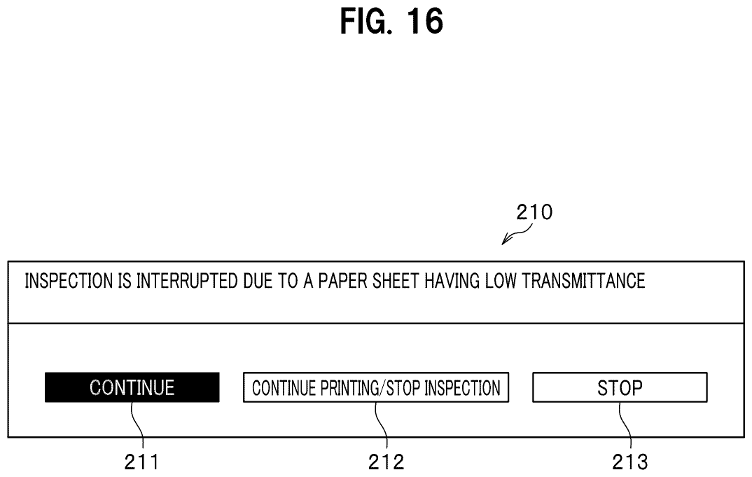

FIG. 16 shows an example of a designation screen for designating an operation when the inspection device 100 interrupts the inspection.

The inspection interruption operation specifying screen 210 includes a character string “Inspection is interrupted due to a paper sheet having low transmittance.”, a “continue” button 211, a “continue printing/stop inspection” button 212, and a “stop” button 213.

When the inspection device 100 interrupts the inspection, the inspection interruption operation specifying screen 210 is displayed. At this time, when the “continue” button 211 is pressed, the printing and the inspection are continued. When the “continue printing/stop inspection” button 212 is pressed, printing is continued and inspection is stopped. When the “stop” button 213 is pressed, printing and inspection are stopped.

As described above, according to the inspection device 100 of this embodiment, it is possible to select the subtraction mode (first and third embodiments) or the combining mode (second and fourth embodiments), to specify the lower limit of the medium transmittance at which the inspection operation is enabled, and to specify the transporting method when the inspection operation is stopped, using the operation setting screen 200 (FIG. 13).

When the inspection is interrupted, the inspection device 100 displays the inspection interruption operation specifying screen 210 (FIG. 16) on the display operation part 5. This enables the operator to select whether to continue printing and inspection, continue printing and cancel inspection, or cancel printing and inspection, using the inspection interruption operation specifying screen 210.

### Sixth Embodiment

In each of the embodiments, the background image is specified using the scanned image for each page of the reference medium and the inspection medium (step S4 (FIG. 5), step S14 (FIG. 8), step S34 (FIG. 10)), but the background image can be specified only for the first page.

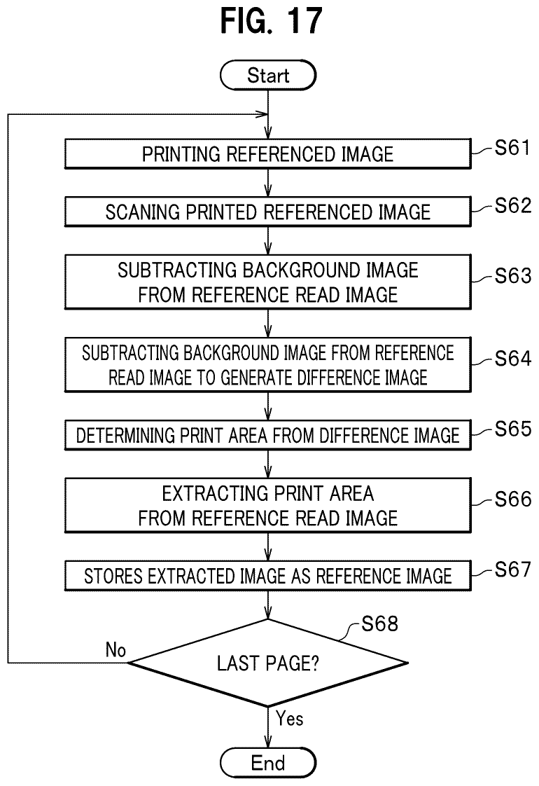

FIG. 17 is a flowchart for explaining a method of generating a reference image in an inspection method of a sixth embodiment of the present invention. The following is a description replaceable with the operation example of the inspection method by subtraction of the first embodiment.

When the flow is started, the reference image generating part 11 prints the material image 37 (FIG. 4) as a referenced image on the medium (step S61). After the execution of step S61, the reading controller 22 causes the reading part 1 to scan the printed referenced image (step S62).

After the execution of the step S62, the reference image generating part 11 stores the background image 32a of the first page by using the reference read image 31a scanned in the step S62 (step S63). After the execution of the step S63, the image subtraction part 14 subtracts the background image 32a from the reference read image 31a to generate a difference image (reference image 33a) (step S64). After the execution of step S64, the reference image generating part 11 determines the print area 41 (FIG. 6) from the difference image (reference image 33a) (step S65). The print area 41 is an area where there is no change in comparison between the outer edges of the reference image 33a and the reference read image 31a, for example. After the execution of the step S65, the reference image generating part 11 extracts the print area 41 determined in the step S65 from the reference read image 31a (FIG. 4) scanned in the step S62 (step S66). After the step S66 is executed, the reference image generating part 11 stores the image extracted in the step S66 as a reference image in the storage part 30 (step S67). After the execution of the step S67, the reference image generating part 11 determines whether or not the last page of the material image 37 is subjected to the printing, scanning, or the like (step S68). If the subject is not the last page (No in step S68), the process returns to step S61, and the reference image generating part 11 prints the material image of the next page on the medium. On the other hand, if the subject is the last page (Yes in step S68), the process is terminated.

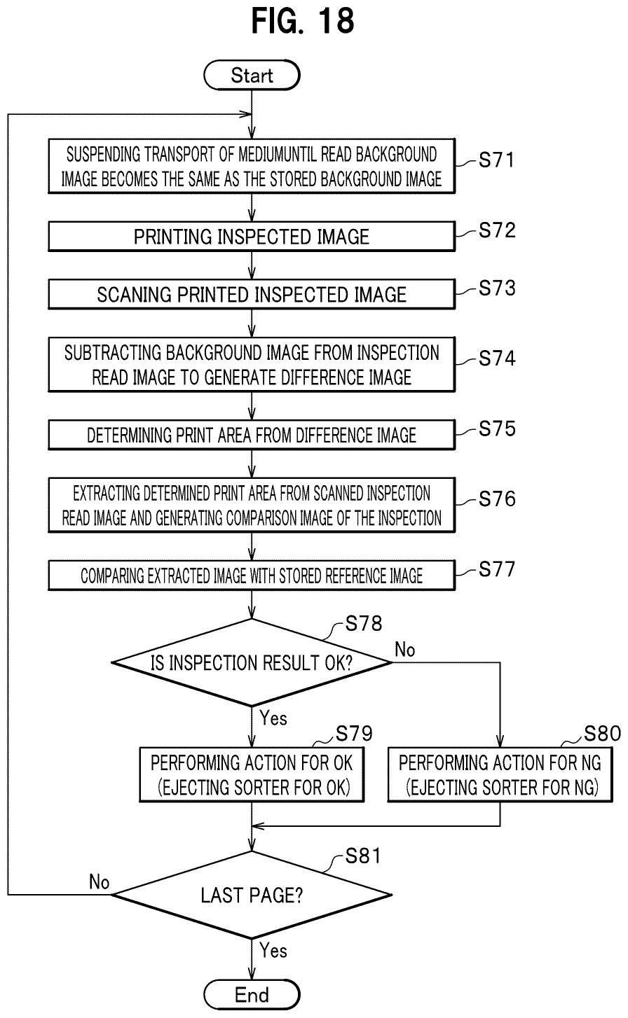

FIG. 18 is a flowchart for explaining a method of generating the inspection image and comparing the inspection image with the reference image in the inspection method of a sixth embodiment of the present invention. The following is a description replaceable with the operation example of the inspection method by subtraction of the first embodiment.

The controller 20 rotates the drum 6 while suspending the transport of the medium (paper sheet) (step S71) until the read background image becomes an image at the same position as the stored background image. After step S71, the inspection image generating part 12 prints the inspected image 38 (FIG. 4) on the medium (step S72). After the execution of step S72, the reading controller 22 causes the reading part 1 to scan the printed inspected image (step S73).

After the execution of the step S73, the image subtraction part 14 subtracts the background image 32b from the inspection read image 34a to generate a difference image (inspection image 35a) (step S74). After the execution of step S74, the inspection image generating part 12 determines the print area 41 (FIG. 6) from the difference image (inspection image 35a) (step S75). The print area 41 is an area where there is no change in comparison between the outer edges of the inspection image 35a and the inspection read image 34a, for example. After the execution of step S75, the inspection image generating part 12 extracts the print area 41 determined in step S75 from the inspection read image 34a (FIG. 4) scanned in step S73, and generates a comparison image of the inspection (step S76).

After the execution of step S76, the comparison and determination part 13 (FIG. 1) compares the image extracted in step S76 with the reference image stored in the storage part 30 (step S77), and performs inspection. After the execution of step S77, the comparison and determination part 13 determines whether or not the inspection result is OK (step S78). If the inspection result is OK (Yes in step S78), the driving controller 23 performs control so as to eject the inspection medium to a sorter for OK (step S79). On the other hand, if the inspection result is NG (No in step S78), the driving controller 23 performs control so as to eject the inspection medium to a sorter for NG (step S80). After the step S79 or the step S80 is executed, the controller 20 determines whether or not the last page of the inspected image 38 is subjected to the printing, the scanning, or the like (step S81). If the subject is not the last page (No in step S81), the process returns to step S71, and the controller 20 performs control so as to print the inspected image of the next page on the medium. On the other hand, if the subject is the last page (Yes in step S81), the process of FIG. 18 is terminated.

As described above, the inspection device of this embodiment stores the background image 32a of the first page using the reference read image 31a (FIG. 4) (step S63). Further, the transport of the medium (paper sheet) is suspended until the read background image becomes an image at the same position as the stored background image (step S71). This eliminates the need for a process of searching for a matching background image from a plurality of (three) stored background images when generating a difference image (inspection image 35a) (FIG. 4) (step S74).

### Modification

The present invention is not limited to the above embodiments, and can be modified without departing from the scope of the present invention.
(a) The background images 32a, 32b (FIG. 4), 32c (FIG. 9) of the first and second embodiments are suction surface images of the sheet suction parts 6a 6b, 6c viewed by the reading part 1 through the transparent medium, but may be suction surface images of the sheet suction parts 6c, 6b, 6a viewed in a non-medium state.
(b) In each of the above embodiments, the medium measurement part 2 measures the transmittance of the medium, but may measure the color. In this case, color correction is performed instead of density correction.
(c) The first and second embodiments use a transparent medium, and the third and fourth embodiments use a semi-transparent medium. If a light-transmitting medium including a transparent medium and a semi-transparent medium is used, the first and second embodiments and the third and fourth embodiments are common. However, in the first and second embodiments, it is necessary to obtain the background images 32a, 32b (FIG. 4), and 32c (FIG. 9) on a transparent medium, not on a non-medium state (the modification (a)).
(d) In the sixth embodiment, the drum 6 is rotated while the driving part 4 (FIG. 1) suspends the transport of the medium (step S71), but the medium may be transported (medium transport) while the rotation of the drum 6 is stopped. That is, the driving part 4 may perform idle feeding (idle feeding) of the medium.
(e) In each of the above embodiments, the read image (reference read image 31a, inspection read image 34a, etc.) is used to compare with a plurality of background images (images of suction surfaces 6d of sheet suction parts 6a, 6b, and 6c) stored in the storage part 30, and one background image is specified (step S4 (FIG. 5), step S14 (FIG. 8), step S34 (FIG. 10)). Accordingly, the inspection part 25 specifies the divided surface (suction surface of sheet suction parts 6a, 6b, and 6c) to which the medium is suctioned. The divided surface may be specified by using rotation angle information of the rotating member (drum 6) detected by a sensor (for example, a rotary encoder) included in the driving part 4 (FIG. 1) or by using a code added to the divided surface obtained by dividing the cylindrical surface.
(f) Although the drum 6 is used as the rotating member in the above embodiments, the suction surface 6d may be a flat surface.

According to the present invention, the influence of the image of the holding surface that holds the inspection medium can be eliminated.

Although embodiments of the present invention have been described and illustrated in detail, the disclosed embodiments are made for purposes of illustration and example only and not limitation. The scope of the present invention should be interpreted by terms of the appended claims.

1. An inspection device comprising:
a holder that holds an inspection medium that is a medium on which an image is formed;
an image sensor that reads the image on the inspection medium; and
a controller that inspects the inspection medium by comparing, with a reference image, an inspection image obtained by performing image processing on a read image read by the image sensor, wherein
the holder has a non-plane surface as a holding surface, and
the controller changes one or both of the inspection image and the reference image based on a transparency of the medium.

2. The inspection device according to claim 1, wherein
the medium is a transparent medium,
the controller generates a background image by capturing an image of the holding surface on which no medium is held, or a background image by capturing an image of the transparent medium held on the holder,
the reference image is a difference image between the background image and an image formed on the transparent medium held on the holder, and
the inspection image is a difference image between an image obtained by reading the inspection medium by the image sensor and the background image.

3. The inspection device according to claim 1, wherein
the medium is a transparent medium,
the controller generates a background image by capturing an image of the holding surface on which no medium is held, or a background image by capturing an image of the transparent medium held on the holder, wherein
the reference image is a composite image obtained by combining an image of the medium on which the image is formed and the background image, and
the inspection image is an image obtained by reading the inspection medium by the image sensor.

4. The inspection device according to claim 1, further comprising;
the medium is a transparent medium,
the controller generates a background image by capturing an image of a light-transmitting medium held on the holder, wherein
the reference image is a difference image between the background image and an image formed on the light-transmitting medium held on the holder, and
the inspection image is a difference image between an image obtained by reading the inspection medium by the image sensor and the background image.

5. The inspection device according to claim 1, further comprising;
the medium is a light-transmitting medium,
the controller generates a background image by capturing an image of the light-transmitting medium held on the holder, wherein
the reference image is a composite image obtained by combining the image formed on the medium and the background image, and
the inspection image is an image obtained by reading the inspection medium by the image sensor.

6. The inspection device according to claim 2, wherein
the reference image is only a print area.

7. The inspection device according to claim 2, wherein
the transparency of the medium is a transmittance of the medium, and
the controller performs an inspection operation when the transmittance of the medium is higher than a reference value.

8. The inspection device according to claim 7, wherein
a density of the background image is changed depending on the transmittance of the medium.

9. The inspection device according to claim 7, further comprising
an I/O interface that receives an input to specify the transmittance.

10. The inspection device according to claim 7, further comprising
a medium sensor that measures the transmittance of the medium.

11. The inspection device according to claim 2, wherein
a color of the background image is adjusted depending on a color of the medium.

12. The inspection device according to claim 11, further comprising
a medium sensor that measures the color of the medium.

13. The inspection device according to claim 2, wherein
the holder holding part is a rotator,
the holding surface is a cylindrical surface divided into a plurality of divided surfaces in a rotational direction,
a plurality of the background images are stored respectively for the divided surfaces, and
the controller performs the comparing while recognizing images of the divided surfaces.

14. The inspection device according to claim 13, wherein
the inspection medium is a plurality of mediums on which different images are formed,
the reference image is stored in a storage over a plurality of pages from a first page to correspond to the inspection medium,
the controller performs idle feeding of the rotator until a suction surface of the rotator to which at least one of the mediums is sucked matches a suction surface of the rotator corresponding to the first page of the reference image, and performs image formation and inspection from the matched position.

15. The inspection device according to claim 13, wherein
the inspection medium is a plurality of mediums on which different images are formed,
the reference image is stored in a storage over a plurality of pages from a first page to correspond to the inspection medium,
the controller performs medium transport until a suction surface of the rotator to which at least one of the mediums is sucked matches a suction surface of the rotator corresponding to the first page of the reference image, and performs image formation and inspection from the matched position.

16. The inspection device according to claim 13, wherein
the controller compares an image of a suction surface of the rotator to which at least one of the mediums is sucked with an image of each of the divided surfaces stored in the storage, and identifies, among the divided surfaces, a divided surface to which at least one of the mediums is sucked.

17. The inspection device according to claim 13, further comprising:
a driver to that rotates the rotator, wherein
the controller identifies, among the divided surfaces, a divided surface to which at least one of the mediums is suctioned using rotation angle information of the rotator detected by a sensor.

18. The inspection device according to claim 13, wherein
a code for identifying each of the divided surfaces is added to the divided surfaces, and
the controller identifies, among the divided surfaces, a divided surface to which at least one of the mediums is suctioned by using the code.

19. The inspection device according to claim 1, wherein
the controller interrupts image forming and inspection upon determining not to perform an inspection operation in a middle of an inspection.

20. An inspection method executed by an inspection device comprising:
a holder that holds an inspection medium that is a medium on which an image is formed, and has a non-plane surface as a holding surface;
an image sensor that reads the image on the inspection medium; and
a controller that inspects the inspection medium by comparing, with a reference image, an inspection image obtained by performing image processing on a read image read by the image sensor, wherein
the controller changes one or both of the inspection image and the reference image based on a transparency of the medium.
